(19) United States
(12) Patent Application Publication
(10) Pub. No.: US 2010/0242226 A1
(43) Pub. Date: Sep. 30, 2010

(54) Door chock tool

(76) Inventors: Edward Cameron Nind Hopkins, Henderson, NV (US); William H. Rogers, St. Augustine, FL (US); Matthew E. McKendrick, Jacksonville, FL (US)

Correspondence Address: R. Tracy Crump, P.O. Box 604, New Carlisle, IN, 46552-0604, US

(21) Appl. No.: 12/384,092

(22) Filed: Mar. 31, 2009

(51) Int. Cl. E05F 5/00

(52) U.S. Cl. 16/82

(57) ABSTRACT

A door chock tool is disclosed that can be used to reliably hold a swinging hinged door open or closed regardless of the size and weight of the door or the surface of the floor under the door. The door chock tool is molded or formed as a single unit from a durable, light weight plastic material and has a wedge member extending from the front of a central body and a T-handle extending from the rear of the central body. When the door chock tool is forcefully wedged under a door by a user forcefully kicking the back of the central body, the wedge member and T-handle flex slightly creating a leaf spring effect, which increases the holding force that secures the door in either an open or closed position.

This invention relates to door chocks for propping and securing swinging doors opened and closed, and in particular a door chock tool for use in tactical and emergency applications.

### BACKGROUND AND SUMMARY OF THE INVENTION

Military, law enforcement, EMS and fire/rescue personnel often need to prop and secure swinging hinged doors open and closed in a variety of tactical and emergency situations. Such personnel often carry simple wooden shims, which are jammed under swing doors to hold them open or closed. Shims of metal, rubber and plastic have also been used as wedges to chock doors open and closed. Other specialized door chocks have been developed for firefighters and EMS personnel, such as the ones disclosed in U.S. Pat. No. 6,616,128. Heretofore, these “wedge” type door chocks (“door wedges”) have proven unreliable in tactical and emergency applications, where it is absolutely critical that they function to prop and secure a doorway open or shut. Door wedges rely on the friction between the shim or wedge and the floor to provide the holding force against the door. On a smooth floor, such as tile or finished concrete, the outward force of a heavy swinging door will quickly overcome the holding force of the door wedge. To improve the holding force, door wedges have been developed that include textured bottom surfaces, rubber pads, spikes and ridges to increase the grip (friction) that the wedge has on the floor. Despite these efforts and improvements, the outward force of a heavy swinging door can readily overcome the holding force of conventional door wedges in many situations. In tactical and emergency situations, door chocks must perform reliably and hold swinging doors fast, regardless of the weight of the door or the type or condition of the floor under the door.

The present invention provides a door chock tool that can be used to reliably hold a swinging hinged door open or closed regardless of the size and weight of the door or the surface of the floor under the door. The door chock tools of this invention can either be used as a door wedge where it is jammed under a swinging door or as a door jam chock where it is inserted into the gap between the door stiles and jam to prop a swinging hinged door open. Each embodiment of the door chock tool is molded or formed as a single unit from a durable, light weight plastic material and has a wedge member extending from the front of a central body and a T-handle extending from the rear of the central body. When the door chock tool is forcefully wedged under a door by a user forcefully kicking the back of the central body, the wedge member and T-handle flex slightly creating a leaf spring effect, which increases the holding force that secures the door in either an open or closed position.

The molded plastic construction of the door chock tool makes them strong, durable and lightweight. The T-handle design makes the tool easy for users to handle and manipulate even when wearing heavy gloves. For transportation convenience, the tools can be readily carried in a pouch or attached to a user's person or gear using lengths of cord and carabiners. Different embodiments of the door chock tool of this invention may also incorporate lights for illumination in low visibility environments and other types of electronic circuitry for additional features and functionality in tactical and emergency applications.

Other advantages will become apparent upon a reading of the following description.

### BRIEF DESCRIPTION OF THE DRAWINGS

The preferred embodiments of the invention have been depicted for illustrative purposes only wherein:

FIG. 1 is a perspective view of an embodiment of the door wedge of this invention;

FIG. 2 is a top view of the door wedge of FIG. 1;

FIG. 3 is a bottom view of the door wedge of FIG. 1;

FIG. 4 is a right side view of the door wedge of FIG. 1;

FIG. 5 is a left side view of the door wedge of FIG. 1;

FIG. 6 is a front view of the door wedge of FIG. 1;

FIG. 7 is a back view of the door wedge of FIG. 1;

FIG. 8 is a side view of the door wedge of FIG. 1 positioned initially under a swinging door;

FIG. 9 is a side view of the door wedge of FIG. 1 forced under a swinging door to hold the door in place;

FIG. 10 is a partial perspective view of the door wedge of FIG. 1 inserted between a door stile and the door jam and seated atop a door hinge;

FIG. 11 is a top view of the door wedge of FIG. 1 inserted between a door stile and the door jam and seated atop a door hinge;

FIG. 12 is a perspective view of a second embodiment of the door wedge of this invention; and

FIG. 13 is a left side view of the door wedge of FIG. 12.

### DESCRIPTION OF THE PREFERRED EMBODIMENTS

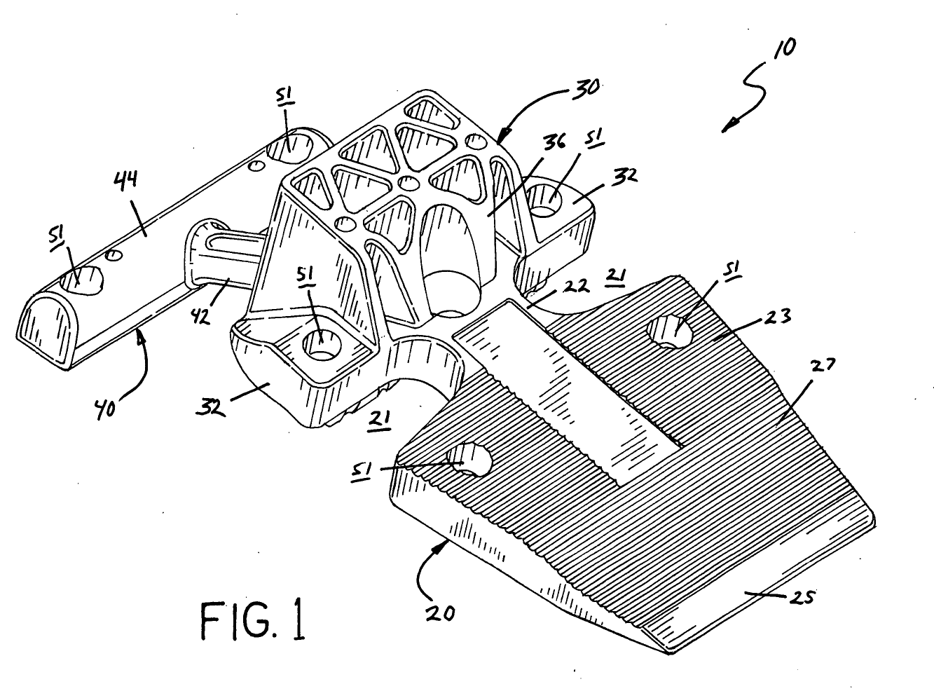

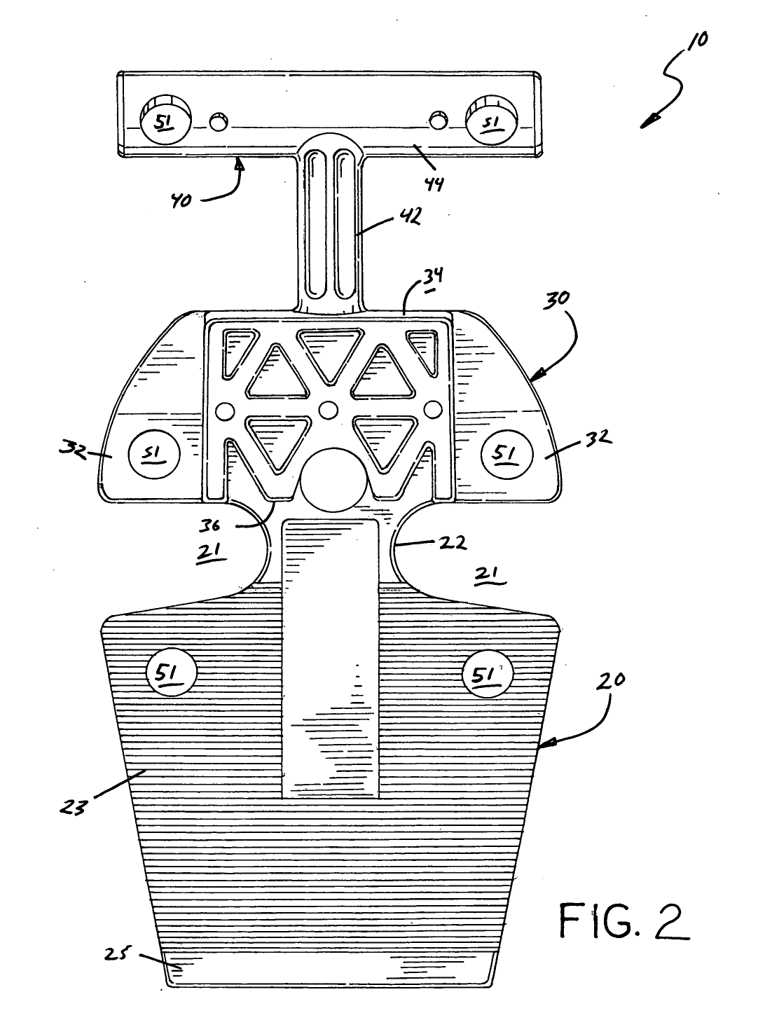

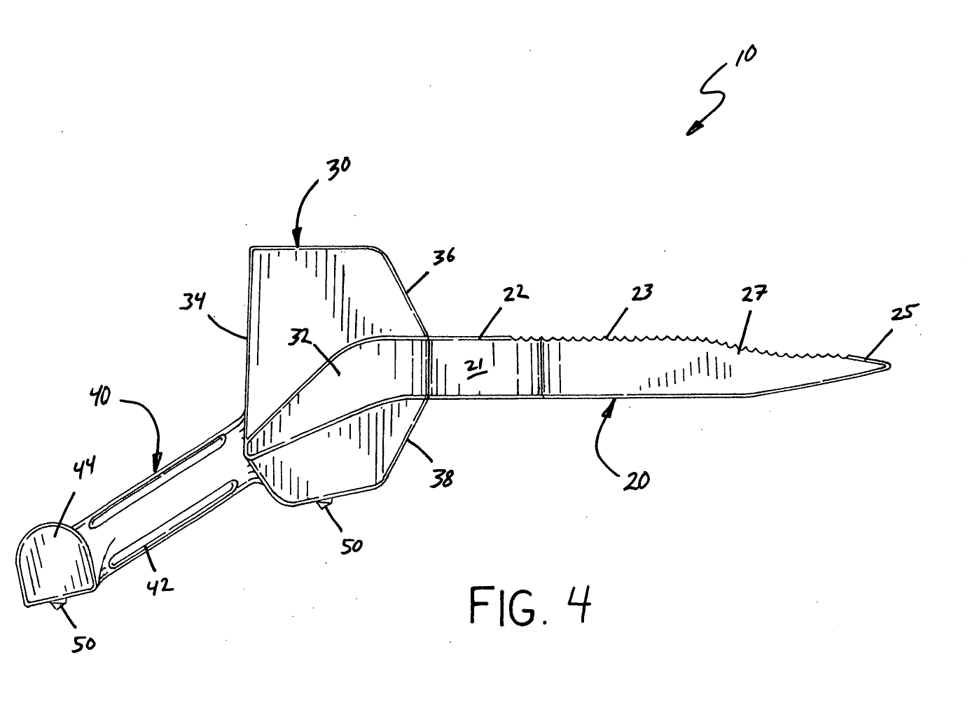

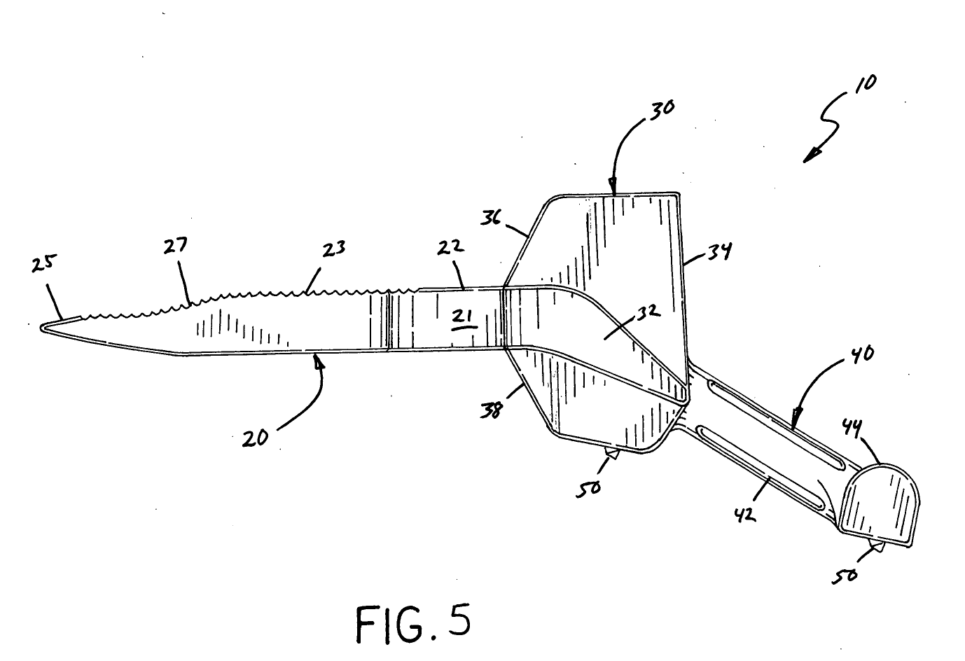

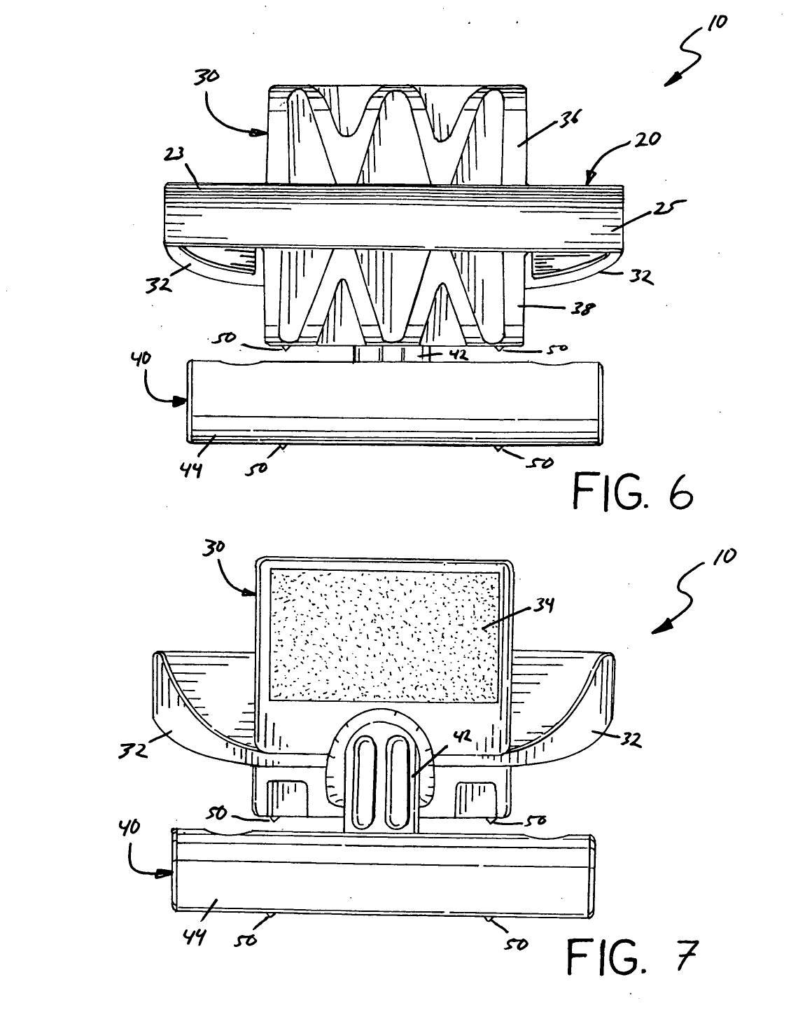

Referring now to the drawings, FIGS. 1-10 show an embodiment of the door chock tool of this invention, which is designated generally as reference number 10. Door chock tool 10 is molded or formed as a single unit from a suitable light weight durable plastic material. Door chock tool 10 includes a wedge member 20 extending from the front of a central body 40 and a T-handle 40 extending from the rear of the central body. Wedge member 20 is configured in the shape of a flat “spade” with a trapezoidal head and a neck 22 defined by two opposed U-shaped notches 21. The top surface of wedge member 20 has lateral striations 23 and terminates in a smooth contact edge 25. The bottom surface of wedge member 20 has a number of core-outs in numerous configurations to reduce weight and material. Wedge member 20 is generally flat, but at its distal end the top and bottom surfaces taper and converge to form a wedge shaped cross section. As best shown in FIGS. 4 and 5, the distal end of the top surface of wedge member 20 has a stepped taper with a middle area 27 having a slope, which is slightly stepper than the slope at contact edge 25. When door chock tool 10 is jammed under a door, the steeper slope near the middle of wedge member 20 allows the load on the door to bind closer toward central body 30. Central body 30 has a number of core-outs in numerous configurations to reduce weight and material. A pair of shoulder flanges 32 extends from either side of central body 30. As best shown in FIGS. 4 and 5, the rear of central body 30 has an angled “kick” face 34 and the front of central body 30 has two angled “stop” faces 36 and 38. Kick face 34 is textured to provide a rough textured contact surface (FIG. 7). Stop faces 36 and 38 are symmetrical to the longitudinal plane of wedge blade 30 and slope forward at approximately a 60° angle. T-handle 40 has a central strut or leg 42 and a long integral cross member 44. As shown, T-handle leg 42 extends longitudinally from central body 30 below and at approximately a 30° angle to the longitudinal plane of blade head 20. Cross member 34 extends approximately the entire width of spade head 20 and has a flat bottom surface.

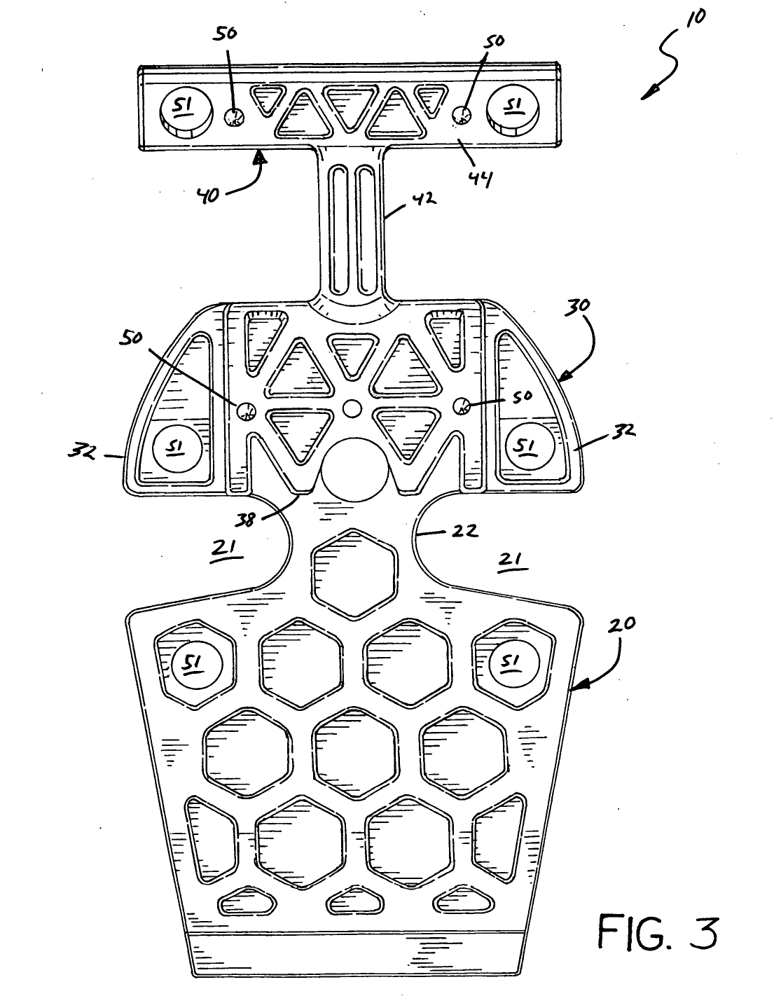

As shown in FIGS. 3-5, metal spikes 50 of brass or steel are press fitted or threaded into bores in the flat bottom of T-handle cross member 44 and the bottom of central body 40. While separate metal spikes are shown, spike may be molded or formed directly into the T-handle cross member 44 and the central body as desired within the teaching of this invention. It should be noted that spikes 50 are angled slightly rearward to provide more “bite” which prevents door chock tool 10 from sliding backwards against the swing force of a door. Door chock tool 10 also has several through bores 51 located in the spade head 20, central body shoulder flanges 32 and T-handle cross member 44. Bores 51 provide openings where lengths of cord can be tied or where carabiners and other connecters can fasten for use in securing door chock tool 10 to a user.

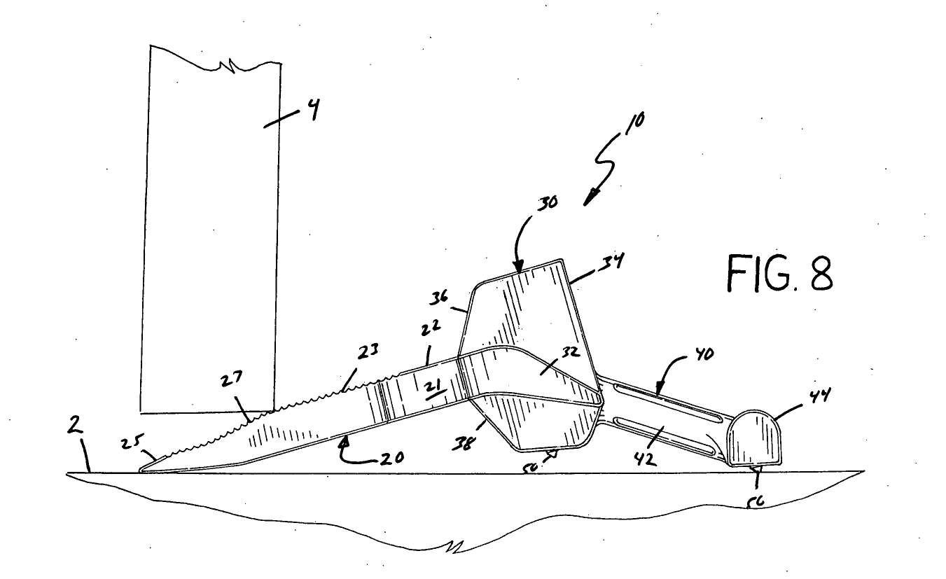

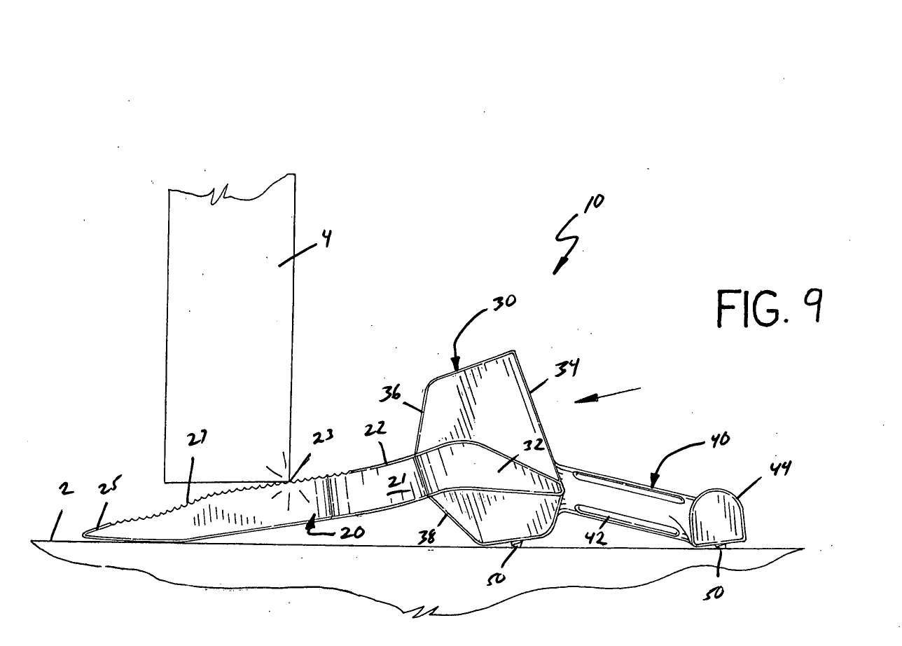

FIGS. 8 and 9 illustrate one method of using door chock tool 10 as a door wedge to prop a swinging door 4 open or closed. Door chock tool 10 is simply placed on the floor in front of a swinging door 4 and slid forward so that spade member 20 extends partially under the bottom of door 2 (FIG. 8). When door chock tool 10 rests naturally atop the floor, the bottom of central body 30 is spaced above the floor and only the distal edge of spade head 22 and cross member 44 contacts the floor. Next, door chock tool 10 is jammed under door 2 driven further toward and under door 4 by a user forcefully kicking the “kick” face 35 with the toe of the user's foot. Kicking door chock tool 10 under door 2 causes wedge member 20 and T-handle 20 to flex slightly, which creates a leaf spring effect. The resilience of the flexing of wedge member 20 and T-handle 40 exerts an upward vertical force against the bottom of door 4 and a downward force on spikes 50 driving them into floor 2 (FIG. 9). Spikes 50 on the bottom of central body 30 and T-handle cross member 34 bite into the floor 2 preventing door chock tool 10 from sliding back away from door 4. The bottom edge of door 2 bites against striations 25 on the top surface of wedge member 20. The leaf spring effect created by the bending and flexing of wedge member 20 and T-handle 40 provides the holding force, which secures door 4 in either an open or closed position.

Ideally, door chock tool 10 is formed or molded from a polymer plastic having sufficient properties and characteristics to give the door wedge high strength, durability and heat resistance, while maintaining a degree of flexible resilience and fracture resistance. Generally, Door chock tool 10 is molded or formed from a plastic, such as glass filled Nylon, although other suitable plastics can be used. The amount of glass fibre added to the nylon should not exceed thirty percent (30%) in order for the door wedge to maintain its resilience and provide the holding force from the leaf spring action of the T-handle and wedge blade. It should also be noted that the dimension and configuration of wedge neck 22 and T-handle leg 42 are also selected to provide the mechanical resilience, which creates the leaf spring effect. The flex in wedge member 20 occurs primarily across wedge neck 22, which has a reduced width. T-handle leg 42 is fluted to reduce weight and material, but also to provide the necessary degree of resilience to T-handle 40.

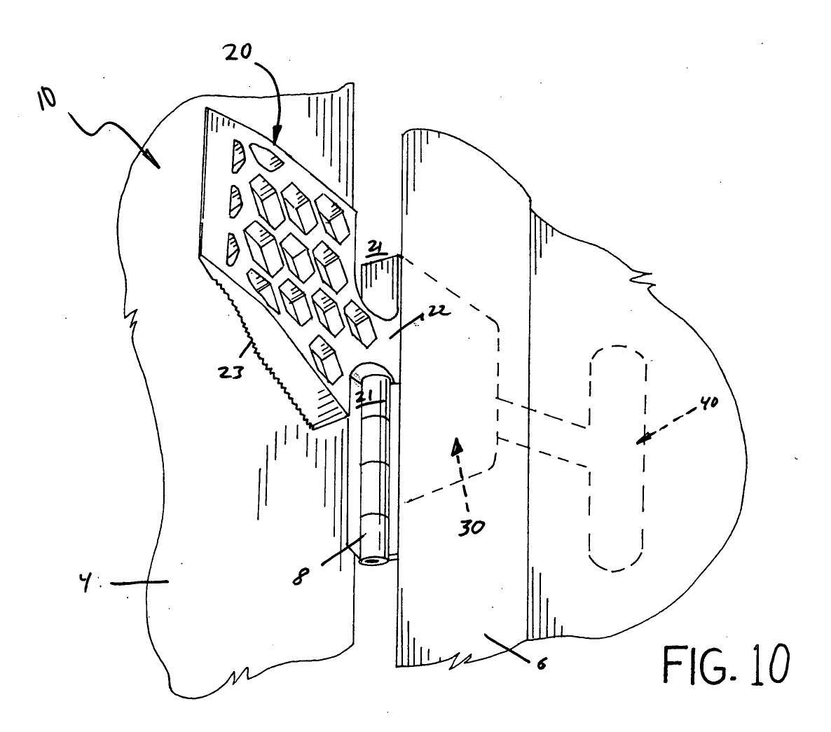

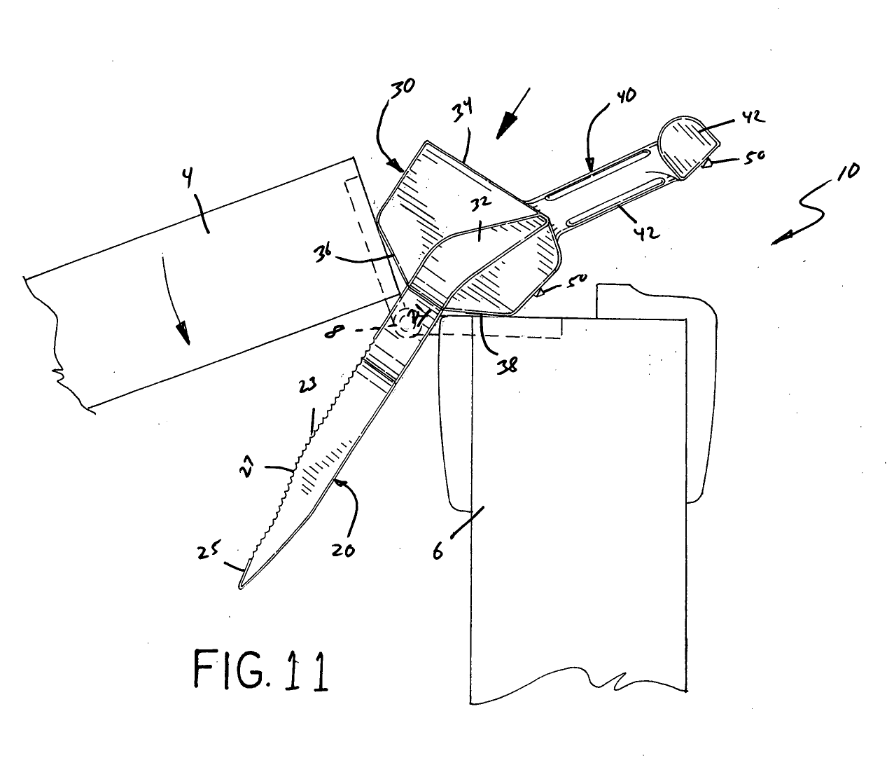

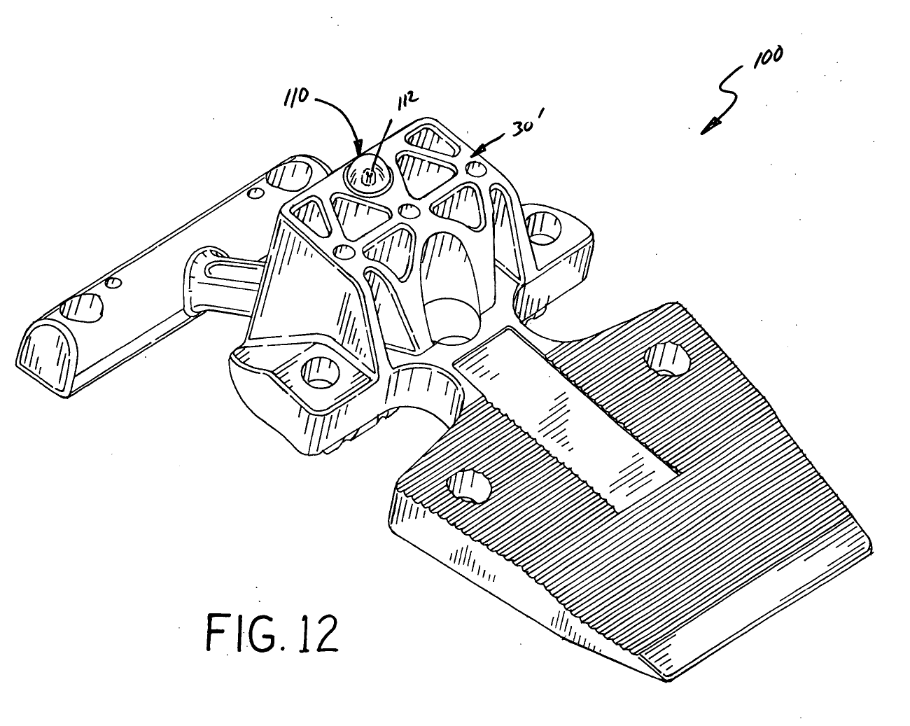

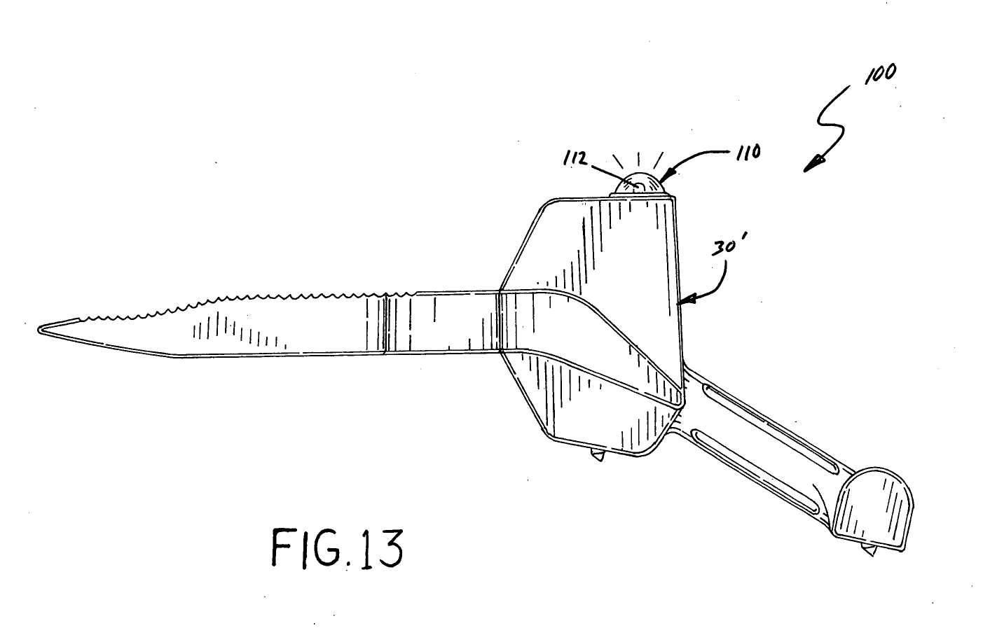

FIGS. 10 and 11 show a second method for using door chock tool 10 to prop open a swinging door. As shown, wedge member 20 of door chock tool 10 is simply rotated on one of its sides and inserted horizontally into the gap 5 between door 4 and door jam 6 above one of the hinges 8. Once inserted, door chock tool 10 is lowered onto hinge 8 so that the hinge seats within slot 21 thereby holding the door wedge in place (FIG. 10). When seated atop hinge 8, contact faces 34 and 36 of central body 30 abut the inner face of door 4 and door jam 6 to prevent the door from opening (FIG. 11). Although not illustrated, it should be noted that door chock tool 10 can be inserted into the gap 5 from either side of the door to prop the door open. Because wedge member 20 has two opposed symmetrical U-shaped slots 21, which can be used to received hinge 8, door chock tool 10 can be inserted with either side of door chock tool 10 facing upward.

FIGS. 11-12 show another embodiment of the door wedge of this invention, which is designated generally as reference number 100. Door chock tool 100 is identical in design and construction, but adds the functionality of illumination. As shown, a light source 102 is mounted to central body 30′. Light 110 employs conventional flashlight and illumination design or technology. As such, light 110 may be powered by any suitable means, although internal DC batteries (not shown) housed within central body 30′ may be the most practical. Ideally, light 110 will employ one or more light emitting diodes (LED)1 12 for low power consumption, although other incandescent bulbs may also be used. Light 110 will also include electronic circuitry (not shown) that provides the desired illumination features and functions. For example, in firefighting application, light 110 may have strobe features, that allows firefighter to use the door wedges to navigate and orientate through heavy smoke. In tactical applications, Light 110 may have a feature that allows it to selectively emit light of different colors. In such an embodiment, door chock tool 100 can be used to mark a cleared room using one color of light, such as white and an uncleared room or area with a different color of light, such as red. Flashlight and illumination technology of this type and having these various features and functions are well known in the art and incorporated into the teachings of this invention.

Other types of electronics can also be incorporated into other embodiments of the door chock tool for various specialized tactical and emergency applications within the teachings of this invention. For example, motion detection circuitry may be incorporated into a tool embodiment. The motion detection circuitry would allow the tool to alert a user if the door is moved or if someone moves through the doorway after the tool is set. Still another tool embodiment may incorporate transmitters, transponders and global positioning satellite (GPS) circuitry to provide precise locations of each door wedge used in a particular situation. While not illustrated herein, the incorporation of such electronics into any embodiment of the door chock tool is within the intended scope and teachings of the present invention.

One skilled in the art will note several advantages of this invention over conventional door wedges. The door chock tools embodying this invention can be reliably used to hold a swinging door open or closed regardless of the size and weight of the door or the surface of the floor under the door. The door chock tool can either be wedged under a swinging door or inserted into the gap between the door stiles and jam to prop a swinging door open. When used as a door wedge jammed under a swinging door, the leaf spring action created by the flexing of the wedge member and T-handle greatly increases the holding force against a swinging door, which ensures that the door will be held open or closed. The tools are strong, durable and light weight. The T-handle makes the tools easy for users to handle and manipulate even when wearing heavy gloves. The tools can be readily carried in a pouch or attached to a person or his gear using lengths of cord and carabiners. Different embodiments of this invention can include a light source to provide illumination in low visibility environments or other electronics for position tracking and motion detection.

The preferred embodiments herein described are not intended to be exhaustive or to limit the invention to the precise form disclosed. They are chosen and described to explain the invention so that others skilled in the art might utilize its teachings. It is understood that the above description does not limit the invention to the details given, but may be modified within the scope of the following claims.

I claim:

1. A door chock tool for securely propping a swinging door hinged to a door jamb from opening and closing, the door chock tool comprising:
a central body, the central body having a front end and a rear end;
a substantially flat wedge member integrally extending from the body front end; and
a handle integrally extending from the body rear end below and at an angle relative to the longitudinal plane of the wedge,
the wedge member and handle constituting means for exerting a holding force on the door when the wedge member is forcefully inserted under the door whereby flexing the wedge member and handle.

2. The door chock tool of claim 1 wherein the wedge member has a distal end adapted for insertion under the bottom of the door and between the door and a door jam.

3. The door chock tool of claim 1 wherein the handle has a T-shaped configuration and includes an elongated leg extending from the body rear end and a cross member integrally connected to the distal end of the handle leg.

4. The door chock tool of claim 1 wherein the body front end has a first surface and a second surface, the first surface of the front end body and the second surface of the front end body for respectively abutting against the door and the doorjam when the wedge member is inserted between the door and the jam to prevent the door from closing.

5. The door chock tool of claim 4 wherein the wedge member extends from the body front end between the first surface of the body front end and the second surface of the body front end, the first surface of the body front end and the second surface of the body front end slope to converge toward the wedge member.

6. The door chock tool of claim 1 wherein the body rear end has a surface adapted to be struck in order to forcefully drive the wedge member under the door.

7. The door stop of claim 1 wherein the wedge member has a trapezoidal shaped head and an integral neck that connects the head to the body front end.

8. The door chock tool of claim 1 wherein the wedge member has a slot therein for receiving a hinge of the door to support the door chock tool atop the hinge when the wedge member is inserted between the door and the door jam.

9. The door chock of claim 1 wherein the central body and handle include spikes adapted to bite into the floor or ground when the wedge member is forcefully inserted under the door.

10. The door stop of claim 1 and a light mounted to the central body.

11. A door chock tool for securely propping a swinging door hinged to a door jamb from opening and closing, the door chock tool comprising:
a central body; a wedge member extending from one end of the central body; and a T-handle extending from the other end of the central body,
the central body having a top, bottom, a first and second front surface adapted to abut the door and doorjamb when the wedge member is inserted between the door and door jamb, and a rear surface adapted to be struck in order to forcefully drive the wedge member under the door, the first front surface and the second front surface sloped to converge toward the wedge member, the central body also includes a plurality of first spikes extending from the bottom thereof;
a wedge member having a trapezoidal shaped and substantially flat head and a neck integrally connecting the wedge member to the central body between the first front surface and the second front surface, the distal end of the wedge head being adapted for insertion under the bottom of the door and between the door and a door jam, the wedge member also having a slot therein for receiving a hinge of the door to support the door chock tool atop the hinge when the wedge member is inserted between the door and the door jam,
the T-handle includes an elongated leg extending from the body rear end and a cross member integrally connected to the distal end of the handle leg, the T-handle leg extends integrally from the central body below and at an angle relative to the longitudinal plane of the wedge, the T-handle also includes a plurality of second spikes extending from the bottom of the T-handle cross member,
the wedge member and T-handle constituting means for exerting a holding force on the door when the wedge member is forcefully inserted under the door whereby flexing the wedge member and handle.

12. The door stop of claim 11 and a light mounted to the central body.
